(19) United States
(12) Patent Application Publication
(10) Pub. No.: US 2017/0252782 A1
(43) Pub. Date: Sep. 7, 2017

(54) METAL CONTAMINATION PREVENTING METHOD AND APPARATUS AND SUBSTRATE PROCESSING METHOD AND APPARATUS USING THE SAME

(71) Applicant: TOKYO ELECTRON LIMITED, Tokyo (JP)

(72) Inventors: Satoru KOIKE, Minato-ku (JP); Keiichi TANAKA, Minato-ku (JP)

(21) Appl. No.: 15/446,192

(22) Filed: Mar. 1, 2017

(30) Foreign Application Priority Data
Mar. 4, 2016 (JP) 2016-042035

(51) Int. Cl. B08B 5/00; B08B 9/027

(52) U.S. Cl. CPC B08B 5/00; B08B 9/027

(57) ABSTRACT

A metal contamination preventing method to be performed prior to using a metal component coated with a passivation film formed of chromium oxide includes generating chromium nitrate by supplying a nitric acid to the passivation film covering a surface of the metal component, and reacting the chromium oxide with the nitric acid and removing chromium from the passivation film by evaporating the chromium nitrate.

### CROSS-REFERENCE TO RELATED APPLICATION

This application claims the benefit of Japanese Patent Application No. 2016-042035, filed on Mar. 4, 2016, in the Japan Patent Office, the disclosure of which is incorporated herein in its entirety by reference.

### TECHNICAL FIELD

The present disclosure relates to a metal contamination preventing method and apparatus and a substrate processing method and apparatus using the same.

### BACKGROUND

In the related art, an ozone supply path using an ozone supply pipe and device, which are made of a stainless steel material or an aluminum material and their gas contact surfaces have been subjected to a passivation process, has been known as an ozone gas supply path that connects an ozone gas supply source and an apparatus using an ozone gas.

In a surface treatment method using an ozone gas when passivating the surface of a stainless steel member by a dry process, there has been known a surface treatment method of a stainless steel member which uses an inert gas having a dew point of—10 degrees C. or lower in a process of raising the temperature of an oxidation process furnace and circulates an exhaust gas, which contains un-reacted ozone discharged from the oxidation process furnace, to an ozone generator as a source gas to reduce oxygen consumption and the amount of exhaust gas.

In a case of using the passivated ozone supply path in a substrate processing apparatus, ozone is supplied to a process chamber through an ozone supply pipe connected thereto, and the so-called aging for supplying ozone into the process chamber having no substrate therein is generally carried out before the start of substrate treatment in the process chamber in order to stabilize the passivation film within the ozone supply path. The aging is performed to prevent metal contamination of stainless steel components in a stainless steel pipe. The passivation film mentioned above is usually formed of a chromium oxide (CrO₃) film. Namely, in a case of using a stainless steel for an ozone supply pipe, an Electrolytic Polishing (EP) process is performed using an electrolyte solution containing a nitric acid of strong oxidation power and the positively ionized stainless steel components are eluted into the electrolyte solution, so that surface smoothing is performed. In this case, since iron has a property of starting to melt prior to chromium in the electrolytic polishing process, chromium on the surface layer is enriched to form a robust passivation film, thereby significantly enhancing corrosion resistance.

FIGS. 1A to 1C are diagrams illustrating a series of processes of performing electrolytic polishing on a pipe in the related art. As illustrated in FIG. 1A, a pipe 210 made of a stainless steel, for example, a pipe 210 made of SUS316L is prepared, and as illustrated in FIG. 1B, an electrolytic polishing process is performed on the pipe 210 using an electrolyte solution 230 containing nitric acid. As a result, a concentrated chromium oxide (CrO₃) film is formed on the surface of the pipe 210, as illustrated in FIG. 1C, to function as a passivation film 220.

The aforementioned aging is aimed at preventing metal contamination by forming a robust and stable passivation film (chromium oxide film) 220 on the surface of the stainless steel pipe 210 by oxidizing the surface using a strong oxidizing gas applied thereto, such as ozone, and then stabilizing the passivation film, and this phenomenon is generally considered to occur on the surface of the stainless steel pipe. The aging for applying the ozone gas in advance requires a considerable period of time in order to prevent metal contamination. This reason is usually considered because the reaction in the ozone gas is weaker than the electrolytic polishing by means of the electrolyte solution.

FIGS. 2A and 2B are views illustrating an example of an aging method in the related art. As illustrated in FIG. 2A, a stainless steel pipe 210 having a passivation film 220 formed on the surface thereof by an electrolytic polishing process and formed of a chromium oxide film is prepared, and as illustrated in FIG. 2B, the passivation film (chromium oxide film) 220 grows by means of an ozone gas supplied thereto. Furthermore, as illustrated in FIG. 2C, the passivation film (chromium oxide film) 220 further grows as an aging process continues. It is considered that metal contamination is prevented by growing and stabilizing the passivation film 220, which is formed of a chromium oxide film, in this way.

Since performing an electrolytic polishing process on a stainless steel and performing an oxide-passivation process using a nitric acid solution are wet processes, moisture is contained in the surface and reacts with NOₓ and Cr to form a Cr compound. Accordingly, an aging process for supplying an ozone gas is required for a long period of time in order to remove the Cr compound. To resolve this problem, an ozonizer has been suggested to reduce a Cr compound by configuring an ozone gas transmission path next to an ozone generation cell by using a material subjected to an oxide-passivation film coating treatment in a dry process.

However, as described above, an ozone gas supply pipe is required to connect a process chamber and an ozonizer when the ozonizer is used to treat a substrate. In the configuration of the conventional ozonizer, since the very short ozone gas transmission path next to the ozone generation cell within the ozonizer is configured, it may be possible to reduce moisture using a material subjected to an oxide-passivation film coating treatment in a dry process. However, in a case of a long pipe, since moisture naturally contained in the air has a great influence, an aging time may not be considerably reduced.

Furthermore, in a case of using a stainless steel pipe, an electrolytic polishing process is generally performed using the aforementioned electrolyte solution containing a nitric acid, and the use of a pipe having undergone a different process leads to a cost increase. Accordingly, it is preferable to reduce an aging time even when using a general stainless steel pipe.

Meanwhile, the related art mentioned above merely discloses a method of processing the surface of an ozone supply pipe made of a passivated stainless steel and the surface of a stainless steel member, but never discloses an aging process when these members are actually used to treat a substrate.

### SUMMARY

The present disclosure provides a metal contamination preventing method and apparatus and a substrate processing method and apparatus using the same that can prevent metal contamination without depending on the formation method or state of a passivation film when using a metal component coated with a passivation film formed of chromium oxide.

According to an embodiment of the present disclosure, there is provided a metal contamination preventing method to be performed prior to using a metal component coated with a passivation film formed of chromium oxide. The metal contamination preventing method includes generating chromium nitrate by supplying a nitric acid to the passivation film covering a surface of the metal component, and reacting the chromium oxide with the nitric acid, and removing chromium from the passivation film by evaporating the chromium nitrate.

According to another embodiment of the present disclosure, there is provided a substrate processing method, wherein the pipe is connected to a process chamber of a substrate processing apparatus. The substrate processing method further comprises processing a substrate by supplying a process gas from the pipe to the process chamber after performing the aforementioned metal contamination preventing method.

According to a further embodiment of the present disclosure, there is provided a metal contamination preventing apparatus for performing a metal contamination preventing process prior to using a metal component coated with a passivation film formed of chromium oxide. The metal contamination preventing apparatus includes a nitric-acid supply unit configured to supply a nitric acid to the passivation film covering the surface of the metal component, and an evaporation unit configured to evaporate chromium nitrate generated by a reaction of the nitric acid, which has been supplied by the nitric-acid supply unit, and the chromium oxide.

According to a further embodiment of the present disclosure, there is provided a substrate processing apparatus including the aforementioned metal contamination preventing apparatus, the pipe to which the metal contamination preventing apparatus is connected, and a process chamber connected to the pipe, wherein the process chamber is capable of processing a substrate received therein by supplying a process gas through the pipe.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIGS. 1A to 1C are views illustrating a series of processes of performing electrolytic polishing on a pipe in the related art.

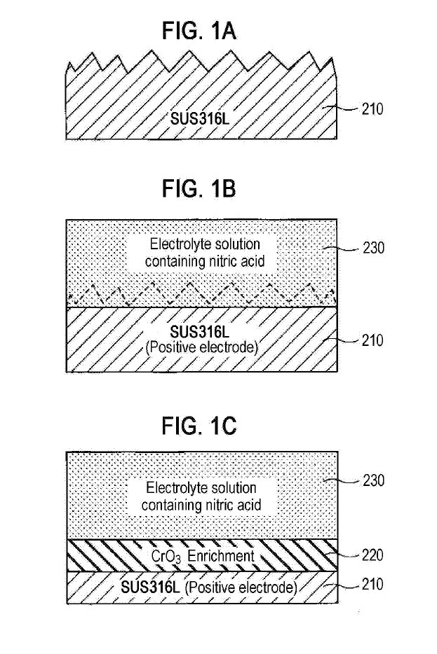

FIGS. 2A to 2C are views illustrating an example of an aging method in the related art.

FIGS. 3A to 3C are views illustrating an example of a metal contamination preventing method according to an embodiment of the present disclosure.

FIG. 4 is a diagram illustrating an example of a metal contamination preventing apparatus and a substrate processing apparatus according to an embodiment of the present disclosure.

FIG. 5 is a diagram illustrating results obtained by implementing the metal contamination preventing method and the metal contamination preventing apparatus in regard to examples 1 to 3 of the present disclosure and comparative example 1.

FIGS. 6A and 6B are diagrams illustrating results implemented by adding comparative example 2, in addition to FIG. 5.

FIGS. 7A and 7B are diagrams illustrating results obtained by analyzing examples 1 to 3 and comparative examples 1 and 2 by Time-Of-Flight Secondary Ion Mass Spectroscopy (TOF-SIMS).

FIG. 8 is a diagram illustrating results obtained by carrying out a metal contamination preventing method according to example 4 of the present disclosure.

FIG. 9 is a diagram illustrating results obtained by carrying out a metal contamination preventing method according to example 5 of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### [Metal Contamination Preventing Method and Substrate Processing Method]

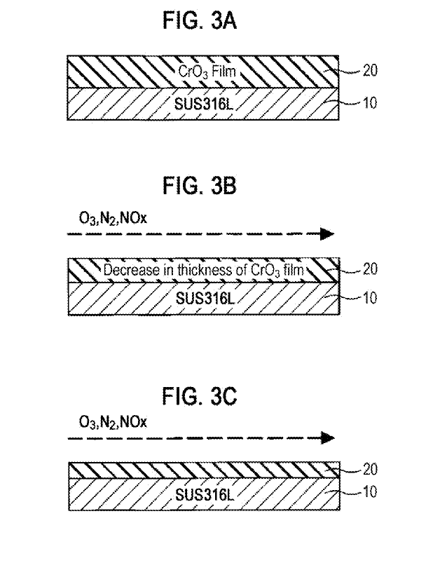

FIGS. 3A to 3C are views illustrating an example of a metal contamination preventing method according to an embodiment of the present disclosure. FIG. 3A illustrates a stainless steel pipe 10 coated with a passivation film 20 made of chromium oxide. As illustrated in FIG. 3A, the stainless steel pipe 10, which the passivation film 20 made of chromium oxide (CrO₃) is formed on the inner circumferential surface thereof, is prepared. The metal contamination preventing method according to the embodiment of the present disclosure may be applied to various metal components such as a valve, a shutter, inner walls of a process chamber and the like in addition to a pipe, as long as the passivation film 20 made of chromium oxide (CrO₃) is formed on the surfaces thereof. Furthermore, although the metal contamination preventing method may be applied to various metal materials such as iron and the like in addition to stainless steel, the embodiment of the present disclosure, which is applied to the stainless steel pipe 10 made of stainless steel, will be described as an example. Further, although an appropriate type of stainless steel may be selected according to its intended use, the embodiment of the present disclosure using SUS316L will be described as an example.

FIG. 3B is a diagram illustrating an example of a nitric-acid generation process. In the nitric-acid generation process, an oxygen-containing gas and a nitrogen-containing gas are supplied to the stainless steel pipe 10 coated with the passivation film 20 to generate NOₓ, and then the NOₓ reacts with moisture, thereby generating a nitric acid (HNO₃). The oxygen-containing gas may be a gas containing an oxygen element (O), such as oxygen (O₂), ozone (O₃), etc., and the nitrogen-containing gas may be a gas containing a nitrogen element (N), such as nitrogen (N₂), ammonia (NH₃), etc. FIG. 3B, illustrates an example in which ozone (O₃) is supplied as the oxygen-containing gas and nitrogen (N₂) is supplied as the nitrogen-containing gas. The ozone and the nitrogen are simultaneously supplied to one place (the stainless steel pipe 10), thereby generating NOₓ. In a case of supplying ozone as an oxidizing gas, the ozone accounts for just 15% of the oxidizing gas, and oxygen accounting for the remainder (about 85%) is usually supplied together. Namely, although ozone is usually generated using an ozone generator, the ozone generator capable of generating only ozone up to 100% from oxygen supplied thereto does not exit, and a current conventional ozone generator generates ozone up to about 15% due to the performance thereof. However, it is sufficiently possible to remarkably improve the performance of an ozone generator in the future. In any case, the metal contamination preventing method according to this embodiment may be applicable as long as NOₓ is generated.

Although water is not directly supplied to the stainless steel pipe 10, the purity of oxygen or nitrogen is usually not 100% and a small amount of water is contained mostly. For example, in a case of supplying nitrogen, even if the purity is high, the nitrogen content is only about 99.99995 vol % and water is contained as much as about 0.5 ppm. Furthermore, a small amount of moisture generally adheres to the surface of the stainless steel pipe 10. Accordingly, even though water is not particularly supplied to the stainless steel pipe 10, a small amount of water exists in the stainless steel pipe 10 to which the nitrogen and the oxygen have been supplied.

Accordingly, the ozone and the nitrogen are supplied to the surface of the stainless steel pipe 10, more accurately, to the surface of the passivation film 20 so that NOₓ (NₓOₓ) and water (H2O) react with each other to generate a nitric acid (HNO3). Further, the generated nitric acid and chromium oxide react as in Equation (1) below.

[Equation 1]

2CrO₃+6HNO₃→2Cr(NO₃)₃↑+3H₂O↑+O₃↑ (1)

Namely, the chromium oxide and the nitric acid react with each other to generate chromium nitrate (Cr(NO₃)₃), water, and ozone. Since the water is automatically generated when the chromium oxide and the nitric acid react with each other, as expressed in Equation (1), it is not necessary to actively supply water once the reaction of Equation (1) occurs. Accordingly, when the ozone and the nitrogen are supplied to the stainless steel pipe 10, the ozone and the nitrogen react with a small amount of water to undergo the reaction of Equation (1), and thereafter the reaction continues. That is, once the reaction of Equation (1) starts, the reaction of Equation (1) continues as long as chromium oxide (CrO₃) exists.

Here, the chromium nitrate (Cr(NO₃)₃) is water-soluble and has a relatively low boiling point of 100 degrees C. However, since the boiling point of the chromium nitrate is higher than room temperature (about 25 degrees C.), it may be considered that eluted Cr is released into the fluid passage of the stainless steel pipe 10 so that other stainless steel components (Fe, Ni, etc.) bonded with the Cr may be also generated as metal contamination.

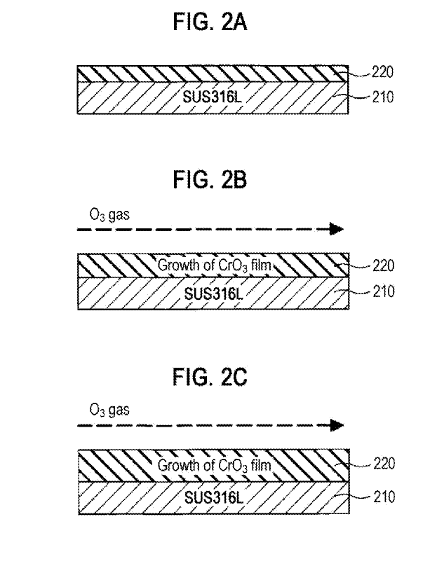

The phenomenon in which metal contamination is gradually dried up (disappears) by means of an aging process of supplying ozone has been described in the background art, but actually, this is not based on the growth and stabilization of the chromium oxide described with reference to FIGS. 2A to 2C, rather it is considered that chromium oxide disappears so that it becomes a state that chromium nitrate is not generated even though ozone is supplied.

Accordingly, since metal contamination exists as long as chromium oxide exists, if the chromium oxide is eliminated by accelerating the reaction of Equation (1) at the aging step, the cause of metal contamination disappears.

Through various aging experiments, inventors have known that when the stainless steel pipe 10 is vacuum-exhausted, metal contamination is relatively rapidly removed so that aging is completed at a short time. Since there are many cases of not heating a process chamber when performing the aging, there are many cases that the temperature of the stainless steel pipe 10 does not reach a temperature of 100 degrees C. that is the boiling point of chromium nitrate, and it is placed in an environment at room temperature (about 25 degrees C.). Thus it is not strange that chromium nitrate serves as the cause of metal contamination. However, if vacuum exhaust is carried out, a saturated vapor pressure decreases. As a result, chromium nitrate evaporates even at room temperature (about 25 degrees C.). Accordingly, it is possible to prevent metal contamination by transforming chromium oxide into chromium nitrate by accelerating the reaction of Equation (1) and then evaporating the transformed chromium nitrate to remove the chromium component from the stainless steel pipe 10. Namely, if the reaction of Equation (1) is accelerated in an environment in which chromium nitrate does not evaporate, metal contamination is generated, whereas if the reaction of Equation (1) is accelerated in an environment in which chromium nitrate evaporates, the chromium component is removed from the surface of the passivation film 20 so that it is possible to make a state of not generating the metal contamination in a short time.

In a conventional aging process, since nitrogen is not supplied while ozone is supplied, a large amount of nitric acid is not generated, so that it is difficult to induce the reaction of Equation (1). Accordingly, it is not unusual that a long time of hundreds of hours is frequently required for aging. In this embodiment, nitrogen as well as ozone is actively supplied to generate a large amount of a nitric acid. Further, the reaction of Equation (1) is caused to remove the Cr component from the surface of the passivation film 20, which results in making a state in which the metal contamination does not occur. This makes it possible to reliably prevent metal contamination by an aging process of a short time.

Furthermore, in order to evaporate the chromium nitrate, the stainless steel pipe 10 may be vacuum-exhausted to reduce the saturated vapor pressure as described above, or the stainless steel pipe 10 may be heated to make an environment with a boiling point of 100 degrees C. Alternatively, a combination of heating and depressurization may be carried out. Any means and method capable of evaporating and removing chromium nitrate while accelerating the reaction of Equation (1) may be used.

FIG. 3C illustrates an example of a chromium nitrate evaporation process. In the chromium nitrate evaporation process, as described above, an oxygen-containing gas and a nitrogen-containing gas are continuously supplied to make an environment in which the reaction of Equation (1) continues and the chromium nitrate evaporates, so that the Cr component is removed from the passivation film 20 to reduce the thickness of the passivation film 20. Accordingly, an environment in which metal contamination does not occur can be efficiently made in a short time.

If the amount of a nitric acid to be generated is increased, the reaction of Equation (1) is accelerated so that the chromium oxide decreases at a high speed. Accordingly, an increased amount of nitrogen to be supplied may be desirable within the range in which a nitric acid can be efficiently generated.

It is desirable to set the concentration of chromium to be decreased within the range of 2 μm or less from the surface of the passivation film 20. This is because a chromium component existing in a deep position of the passivation film 20 rarely affects the surface of the passivation film 20, and the concentration of chromium at a predetermined depth close to the surface of the passivation film 20 is considered to be associated with metal contamination. Furthermore, the concentration of chromium at a predetermined depth may be individually set to an appropriate value in consideration of the specification and purpose of the stainless steel pipe 10.

A nitric acid may be generated by the reaction of NOₓ and H₂O, as described above, or may be directly supplied to the stainless steel pipe 10. In this case, a nitric-acid supply source is prepared to supply a nitric acid to the stainless steel pipe 10. While the concentration of the nitric acid may be set to an appropriate value according to the purpose thereof, the concentration of the nitric acid may be set, for example, within the range of 1 ppb to 5%, or within the range of 1 ppb to 30 ppm.

Although the concentration of each gas may be set to an appropriate value according to the purpose thereof, for example, the concentration of the ozone gas is desirably set to 50% or less. Meanwhile, there are many cases that the ozone gas is actually set to a concentration of 15% or less due to the capability of an ozone generator. It is desirable that the concentration of the oxygen supplied together with the ozone is preferably set to 50% or more. In practice, there are many cases that the concentration of the oxygen is set to at least 85% due to the capability of the ozone generator.

The concentration of the nitrogen may be set, for example, within the range of 1 ppb to 2.5%, or within the range of 0.2 ppm to 2.5%. Furthermore, the concentration of water may be set, for example, within the range of 1 ppb to 2.5%, within the range of 1 ppb to 30 ppm, or within the range of 1 ppb to 0.5 ppm.

The stainless steel pipe 10 may be configured as a pipe for supplying a process gas to a substrate processing apparatus such as a film formation apparatus, an etching apparatus or the like, and the passivation film 20 is formed on the inner circumferential surface of the stainless steel pipe 10. In general, the stainless steel pipe 10 is often applied to a supply pipe of an oxidizing gas, such as an ozone gas, etc. However, if it is a pipe or a metal component, at least a part of which is coated with a passivation film 20 formed of chromium oxide, the stainless steel pipe 100 may be used for various substrate processing methods.

According to the metal contamination preventing method and the substrate processing method, according to the embodiment of the present disclosure, it is possible to reliably prevent metal contamination of a metal component on which a passivation film 20 made of chromium oxide is formed by means of an aging process of a short time. Thus, it is possible to perform a desired process, such as processing a substrate, without generating metal contamination.

Furthermore, it is effective to apply the metal contamination preventing method and the substrate processing method, according to the embodiment of the present disclosure, to an oxidizing-gas supply pipe in order to supply an oxidizing gas to the stainless steel pipe 10, and a process gas other than an oxidizing gas may be supplied to the stainless steel pipe 10 after the passivation film 20 formed of chromium oxide is removed therefrom. Namely, the metal contamination preventing method and the substrate processing method, according to the embodiment of the present disclosure, may be applied to all metal components on which the passivation films 20 made of chromium oxide is formed, and are not limited to special purposes.

### [Metal Contamination Preventing Apparatus and Substrate Processing Apparatus]

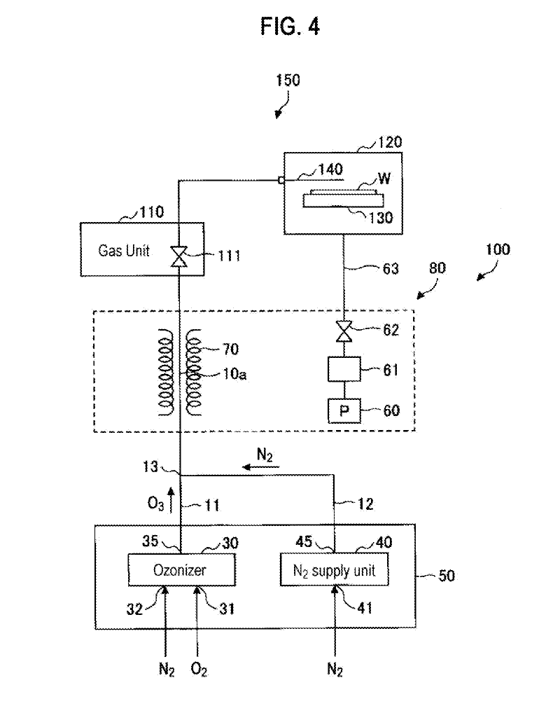

FIG. 4 is a diagram illustrating an example of a metal contamination preventing apparatus and a substrate processing apparatus according to an embodiment of the present disclosure.

The metal contamination preventing apparatus 100, according to the embodiment of the present disclosure, includes a nitric-acid generation unit 50 and an evaporation unit 80. The nitric-acid generation unit 50 includes branch pipes 11 and 12, an ozonizer 30, and a nitrogen supply unit 40. The evaporation unit 80 includes at least one of a vacuum pump 60 and a heater 70.

The substrate processing apparatus 150, according to this embodiment, includes a pipe 10a, the metal contamination preventing apparatus 100, a gas unit 110, a process chamber 120, a substrate stage 130, and a gas discharge unit 140.

As described above with reference to FIGS. 3A to 3C, the pipe 10a is a pipe in which a passivation film 20 is formed on its inner circumferential surface and its surface is covered with a passivation film 20. Similar to the stainless steel pipe 10 described above with reference to FIGS. 3A to 3C, the pipe 10a may be formed of a stainless steel or a different metal material, such as iron, etc. Meanwhile, the passivation film 20 is formed of chromium oxide. The pipe 10a is connected to the process chamber 120 of the substrate processing apparatus 150 to serve as a process gas supply pipe configured to supply a process gas into the process chamber 120. While various gases may be used as process gases according to the purposes thereof, herein, a case of supplying an ozone gas as an oxidizing gas will be described as an example.

The branch pipe 11 is connected to the pipe 10a to supply ozone to the pipe 10a. Accordingly, the downstream side of the branch pipe 11 is connected to the pipe 10a, and the upstream side of the branch pipe 11 is connected to the ozonizer 30. A passivation film 20 may or may not be formed on the inner circumferential surface of the branch pipe 11.

The branch pipe 12 is also connected to the pipe 10a to supply nitrogen to the pipe 10a. Accordingly, the downstream side of the branch pipe 12 is connected to the pipe 10a, and the upstream side of the branch pipe 12 is connected to the nitrogen supply unit 40. A passivation film 20 may or may not be formed on the inner circumferential surface of the branch pipe 12.

The junction 13 of the branch pipes 11 and 12 and the region within the pipe 10a at the downstream side of the junction 13 function as a nitric-acid generation region. That is, a nitric acid is generated and the reaction of Equation (1) is initiated at the junction 13 of the branch pipes 11 and 12.

The ozonizer 30 is a device configured to generate ozone. The ozonizer 30 includes an ozone generation cell (not shown) in an inside portion thereof to generate ozone using an oxygen gas supplied through an oxygen inlet 31. The ozone generation cell generates ozone from the supplied oxygen. For example, ozone of about 15% and oxygen of about 85% are discharged through an ozone outlet 35, as described above. Of course, the ratio of ozone and oxygen to be discharged may be set to various values according to capabilities and purposes without being limited thereto. The ozonizer 30 may include a nitrogen inlet 32 according to necessity.

Nitrogen may be supplied through the nitrogen inlet 32 to be used to clean electrodes of the ozone generation cell. In this case, a small amount of nitric acid may be generated, and in this case, the nitric acid may be discharged together with the ozone through the ozone outlet 35 to be supplied to the pipe 10a.

In many cases, an upper limit of a supply amount of nitrogen is determined in the ozonizer 30 receiving the nitrogen through the nitrogen inlet 32. However, the ozonizer 30, capable of supplying a large amount of nitrogen and discharging a nitric acid or nitrogen through the ozone outlet 35 as it is, can be used as it is. In the metal contamination preventing apparatus 100, according to this embodiment, the nitric-acid generation unit 50 may generate a nitric acid to supply the generated nitric acid to the pipe 10a, and the ozonizer 30 may have various configurations as long as the ozonizer 30 can achieve the function thereof.

The nitrogen supply unit 40 is a means configured to supply nitrogen. The nitrogen supply unit 40 may be configured with, for example, a tank filled with nitrogen and maintaining the same, or a buffer tank having a nitrogen inlet 41 and supplied with nitrogen through the nitrogen inlet 41. The nitrogen supply unit 40 has a nitrogen outlet 45 connected to the branch pipe 12 and serves to supply nitrogen to the pipe 10a.

Further, the metal contamination preventing apparatus 100 does not include a unit configured to supply water. However, since water contained in oxygen or nitrogen or water adhering to the branch pipes 11 and 12 or the pipe 10a is sufficient for the start of the reaction of Equation (1), as described above, it is not necessary to particularly install a means configured to supply water.

The evaporation unit 80 is a unit configured to evaporate chromium nitrate generated within the pipe 10a. By this, it is possible to remove a chromium component from the pipe 10a and the passivation film 20 without depositing the chromium component on the passivation film 20 again.

The evaporation unit 80 includes at least one of the vacuum pump 60 and the heater 70. As described above, it is possible to remove the generated chromium nitrate by evaporating (vaporizing) the same by depressurizing or heating the pipe 10a.

The vacuum pump 60 is connected to the process chamber 120 through an exhaust pipe 63 and is configured to be able to vacuum-exhaust the process chamber 120. Since the process chamber 120 and the pipe 10a are connected with each other, the pipe 10a is depressurized through the process chamber 120 by the vacuum exhaust of the vacuum pump 60. As the interior of the pipe 10a is depressurized, the saturated vapor pressure of the chromium nitrate decreases, and the chromium nitrate is evaporated at a temperature lower than or equal to the boiling point thereof, for example, at room temperature. Accordingly, as a nitric acid is supplied from the nitric-acid generation unit 50 to the pipe 10a while the vacuum pump 60 is carrying out the vacuum exhaust, the reaction of Equation (1) is generated, so that the chromium nitrate can be removed from the passivation film 20.

Furthermore, a flow controller 61, a valve 62, or the like, in addition to the vacuum pump 60, may be installed on the exhaust pipe 63 according to necessity to control the amount of the exhaust gas. While the vacuum pump 60 is illustrated as an example of a depressurization unit in FIG. 4, any unit capable of depressurizing the interior of the atmosphere within the pipe 10a may be used.

The heater 70 is a heating means configured to heat the atmosphere within the pipe 10a. The heater 70 may have any structure capable of being installed around the pipe 10a to raise the temperature of the atmosphere within the pipe 10a. Since the chromium nitrate has a boiling point of 100 degrees C., as described above, the heater 70 is preferably configured to heat the atmosphere within the pipe 10a to a temperature of 100 degrees C. in order to evaporate the chromium nitrate using only the heater 70 without the vacuum pump 60. Of course, this temperature condition is not necessarily essential since the heater 70 may operate in conjunction with the vacuum pump 60 to vaporize the chromium nitrate.

In any case, the evaporation unit 80 may be variously configured if it is capable of evaporating the chromium nitrate generated in the pipe 10a by making the same reach the saturated vapor pressure thereof.

As described above, the metal contamination preventing apparatus 100 has a configuration and a function of evaporating the chromium nitrate generated within the pipe 10a by generating a nitric acid the nitric-acid generation unit 50 and supplying the same to the pipe 10a. This generates the reaction of Equation (1) mentioned above to efficiently perform an aging process in a short time, thereby preventing metal contamination of the pipe 10a.

Although the nitric-acid generation unit 50 illustrated in FIG. 4 is configured to generate a nitric acid from ozone and nitrogen, the nitric-acid generation unit 50 may be configured to directly supply a nitric acid to the pipe 10a as a nitric-acid supply source. If the nitric-acid generation unit 50 is capable of generating and supplying a nitric acid to the pipe 10a, any type of generation unit can be used. Furthermore, there may be provided a means configured to regulate the concentration or flow rate of each gas according to necessity.

Next, the substrate processing apparatus 150 will be described.

The gas unit 110 is a gas supply means configured to supply the process gas, which is supplied from the pipe 10a, to the process chamber 120. The gas unit 110 includes, for example, a valve 111 to control the supply of the process gas to the process chamber 120. Furthermore, the gas unit 110 may include a regulation means (such as a flow controller, etc.) according to necessity to control the flow rate of the process gas.

The process chamber 120 is a container configured to receive a substrate (such as, a wafer W, etc.) and to carry out a predetermined substrate processing. The process chamber 120 includes, for example, the substrate mounting table 130 therein and a predetermined substrate processing (such as a film formation process, etc.) is performed on the surface of the substrate mounting table 130. Furthermore, the gas discharge unit 140 connected with the pipe 10a is installed within the process chamber 120 to supply the process gas, which is supplied from the pipe 10a, into the process chamber 120 to carry out a predetermined substrate processing.

The substrate mounting table 130 may be configured in a table shape, such as a rotary table, or may be configured with a wafer boat having a rack shape in which a plurality of substrates is loaded and held.

The process gas discharged and supplied from the process gas discharge unit 140 may be selected according to contents of a substrate processing. For example, an oxidizing gas (such as ozone, etc.) that is used to oxidize a substrate may be supplied as the process gas.

The vacuum pump 60 mentioned above is connected to the process chamber 120 and is configured to vacuum-exhaust the interior of the process chamber 120. When a vacuum process is performed within the process chamber 120, a substrate processing (such as film forming, etching, etc.) is carried out while vacuum-exhausting the interior of the process chamber 120 by the vacuum pump 60.

According to the substrate processing apparatus 150 of this embodiment, since the metal contamination of the pipe 10a can be prevented, it is possible to prevent metal contamination caused by the pipe 10a, thereby carrying out a high-quality substrate processing. Furthermore, since time required for aging of the pipe 10a can be reduced, it is possible to increase the productivity of the substrate processing.

If the substrate processing apparatus 150 is connected to the pipe 10a and capable of supplying a process gas from the pipe 10a, any type can be used. As described above, the process gas may be an oxidizing gas (such as an ozone gas, etc.), or may be a different type of gas.

In addition, as described above, the metal contamination preventing apparatus 100 can be applied to various metal components on which the passivation films 20 made of chromium oxide are formed in addition the pipe 10a.

### EXAMPLES

Next, an example of implementing the metal contamination preventing method and the metal contamination preventing apparatus according to the embodiments of the present disclosure will be described.

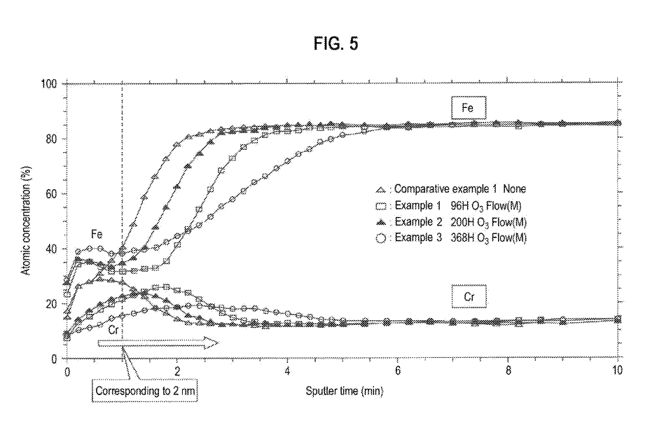

FIG. 5 is a graph illustrating implementation results of the metal contamination preventing method and the metal contamination preventing apparatus in regard to embodiment examples 1 to 3 of the present disclosure and comparative example 1. Comparative example 1 is a stainless steel pipe, which was not subjected to the metal contamination preventing method, and the example 1 is an example, which was subjected to the metal contamination preventing method according to this embodiment for 96 hours. Likewise, the example 2 is an example, which was subjected to the metal contamination preventing method according to this embodiment for 200 hours, and the example 3 is an example, which was subjected to the metal contamination preventing method according to this embodiment for 368 hours. With respect to the examples 1 to 3 and the comparative example 1, the atomic concentrations of Cr and Fe were measured in the depth direction by X-ray Photoelectron Spectroscopy (XPS).

As measurement conditions, an exited X-ray of Al was used, and the detection region had a diameter of 100 μm. In addition, the extraction angle was 45 degrees, and the detection depth was about 4 nm to about 5 nm. The sputter condition was set such that the sputter gas ion was an Ar⁺ ion, the sputter voltage was 1.0 kV, and the sputter rate was about 2 nm. In FIG. 5, the horizontal axis represents the sputter time (min), and the vertical axis represents the atomic concentration (%). A 1-min portion on the horizontal axis corresponds to a depth of 2 nm from the surface layer of the passivation film. Accordingly, a portion with a scale of 2 corresponds to a depth of 4 nm, and a portion with a scale of 4 corresponds to a depth of 8 nm.

First, when the passivation processes were performed as illustrated in FIG. 5, it has a tendency that the ratio of Fe on the surface layers increased, and the ratio of Cr decreased. It is consistent with the explanation so far that the ratio of Cr decreases.

When comparing the Cr with each other, the concentrations in examples 1 and 2 significantly decreased and the concentration in example 3 also significantly decreased more than the concentration in the region at a depth of 2 nm or less from the surface layer in comparative example 1 indicated by Δ. Further, the peak of the concentration in comparative example 1 is located at a location shallower than 2 nm, whereas the peaks of the concentrations in examples 1 to 3 are shifted to the right deep positions (example 1<example 2<example 3). The concentration in the surface layer, particularly, the concentration in a region shallower than 2 μm becomes a problem in metal contamination. As the peak shifts to the right, the concentration in the surface layer decreases. This means that metal contamination is unlikely to occur.

In FIG. 5, it was confirmed that a larger amount of Cr component is removed from the surface layer as the metal contamination preventing method, according to this embodiment, is carried out for a longer period of time. Namely, it was confirmed that an effect of preventing metal contamination can be certainly obtained by carrying out the metal contamination preventing method according to this embodiment.

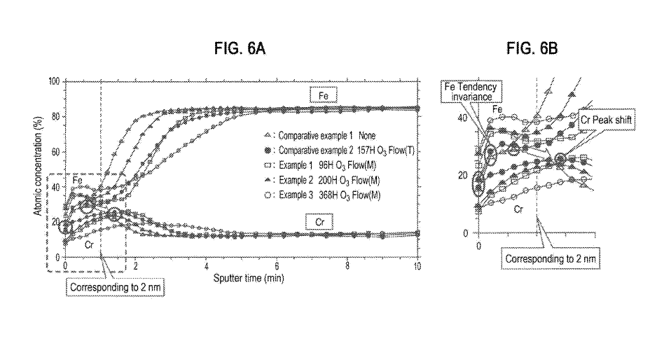

FIGS. 6A and 6B are diagrams illustrating results implemented by adding comparative example 2, in addition to FIG. 5. In comparative example 2, aging was carried out for 157 hours without additional nitrogen. FIG. 6A is an entire diagram, and FIG. 6B is an enlarged diagram of a broken line portion in FIG. 6A.

As illustrated in FIGS. 6A and 6B, in comparative example 2, the Cr concentration in a region shallower than 2 nm from the surface layer is lower than that in comparative example 1, and the peak of the concentration is shifted to a position deeper than 2 nm from the surface. However, the characteristics of the concentration, that is, both the magnitude of the concentration and the location of the peak in comparative example 2, in which aging was carried out for 157 hours, are the same as those in example 1 in which aging was carried out for just 96 hours. Namely, comparative example 2 in which nitrogen was not supplied may exhibit the same characteristics as those of example 1, however, comparative example 2 consumed almost twice the aging time in order to exhibit the same characteristics. According to the metal contamination preventing method, according to this embodiment, it can be seen that a metal contamination preventing state can be achieved in a short time.

Furthermore, in example 2 in which aging was carried out for 200 hours and in example 3 in which aging was carried out for 368 hours, the concentration is clearly lower than that in comparative example 2, and the peak of the concentration is also located in a position far away from the surface layer.

From FIGS. 6A and 6B, it was confirmed that that the metal contamination preventing method, according to this embodiment, in which nitrogen is added, can make a metal contamination preventing state in a shorter time and can make a state capable of more effectively preventing metal contamination by spending time, than the conventional method in which aging is performed using ozone in a simple manner.

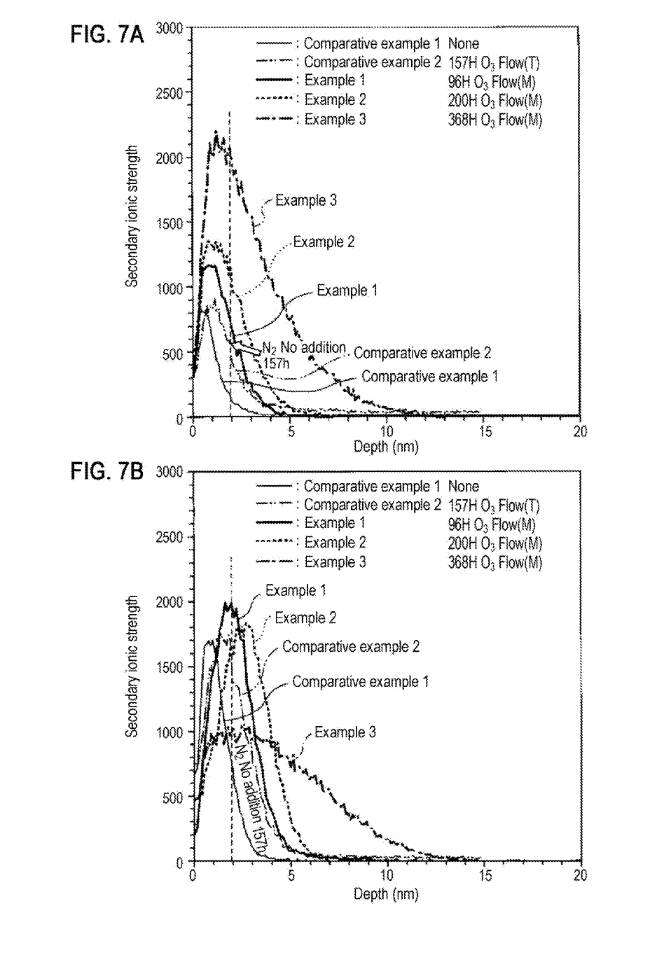

FIGS. 7A and 7B are diagrams illustrating results obtained by analyzing examples 1 to 3 and comparative examples 1 and 2 by Time-Of-Flight Secondary Ion Mass Spectroscopy (TOF-SIMS). FIG. 7A represents the analysis result of Fe, and FIG. 7B represents the analysis result of Cr.

As illustrated in FIG. 7A, in regard to Fe, when nitrogen is not added, the film deposition speed of iron oxide is low, and the film deposition speed becomes higher in the order of example 1, example 2, and example 3. Accordingly, it can be seen that the effect of the metal contamination preventing method, according to this embodiment, is certainly exhibited.

As illustrated in FIG. 7B, in regard to Cr, there is no great difference in the amount of chromium oxide in the outermost layer between the examples, except example 3, and an effect of preventing metal contamination is also obtained in comparative example 2 in which nitrogen is not added. However, the peak of the amount of chromium oxide is shifted to a deeper location in examples 1 and 2 than in comparative example 2, and in particular, the amount of chromium oxide in the surface layer region is less in example 2 than in comparative example 2. Accordingly, in comparative example 2 in which nitrogen is not added, a great effect of preventing metal contamination is not obtained even though aging continues as it is, whereas in the metal contamination preventing method, according to this embodiment, a great effect is certainly obtained as time passes.

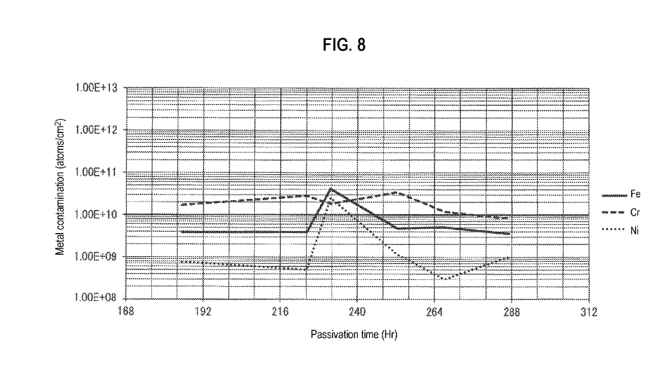

FIG. 8 is a diagram illustrating results obtained by carrying out a metal contamination preventing method according to example 4 of the present disclosure. In example 4, aging was carried out with a considerably small amount of nitrogen under a condition relatively close to the related art in which the effect of the metal contamination preventing method, according to this embodiment, is not obtained much. FIG. 8 shows a time to achieve a predetermined metal contamination preventing state by means of aging. The time to achieve a predetermined metal contamination preventing state refers to a time to reach a threshold value (1.00E+10) of a state in which metal contamination does not occur. As the aging conditions, the flow rate of oxygen was 6 slm, the flow rate of nitrogen was 0.06 sccm (the concentration ratio of nitrogen to oxygen was 100 ppm), and the concentration of ozone was 300 g/Nm³.

In this case, it took 272 hours until the concentration of chromium becomes less than the threshold value (1.00E+10) which may be considered as if the metal contamination has not occurred.

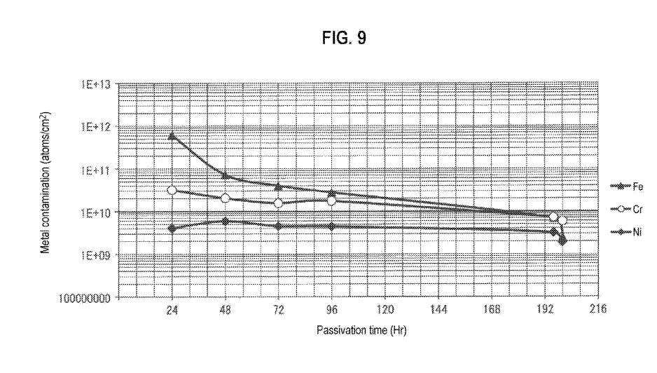

FIG. 9 is a diagram illustrating results obtained by carrying out a metal contamination preventing method according to example 5 of the present disclosure. In example 5, the flow rates of oxygen and nitrogen were set to be considerably large, and the concentration of ozone was also set to be high. Specifically, the flow rate of oxygen was set to 10 slm, which is almost twice that in example 4, and the flow rate of nitrogen was set to 0.1 slm, which is almost twice that in example 4. However, the concentration ratio of nitrogen to oxygen was 100 ppm, which is the same as that in example 4. The concentration of ozone was set to 400 g/Nm³, which is higher than that in example 4. As described above, in example 5, aging was carried out with a larger amount of oxygen, a larger amount of added nitrogen, and a higher ozone concentration than in example 4.

As a result, it took 176 hours to reach a state less than the threshold value (1.0E+10) that represents a predetermined metal contamination preventing state. Since 272 hours were required in example 4, it was possible to reduce the aging time up to almost 100 hours.

As described above, in order to sufficiently obtain the effect of the metal contamination preventing method, according to the embodiment of the present disclosure, the supply amount of oxygen, the supply amount of nitrogen, and the concentration of ozone are increased to sufficiently generate a nitric acid, thereby further reducing the aging time.

Example 4 requires a longer period of time for aging than example 5. However, even in this case, the aging time is reduced, compared to a conventional aging method in which nitrogen is not supplied. Accordingly, it is not impossible to completely obtain the effect of the present disclosure.

As described above, in the metal contamination preventing method and the substrate processing method, according to the embodiments of the present disclosure, it is possible to reduce aging time and to completely prevent metal contamination by discovering optimal conditions.

According to the present disclosure, it is possible to prevent metal contamination when using a metal component coated with a passivation film formed of chromium oxide.

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A metal contamination preventing method to be performed prior to using a metal component coated with a passivation film formed of chromium oxide, the method comprising:
generating chromium nitrate by supplying a nitric acid to the passivation film covering a surface of the metal component, and reacting the chromium oxide with the nitric acid; and
removing chromium from the passivation film by evaporating the chromium nitrate.

2. The method of claim 1, wherein the nitric acid is generated by means of a reaction of a plurality of gases supplied to the metal component.

3. The method of claim 2, wherein the plurality of gases comprise a nitrogen-containing gas and an oxygen-containing gas.

4. The method of claim 3, wherein the nitrogen-containing gas is N₂, and the oxygen-containing gas comprises O₃.

5. The method of claim 3, wherein the nitrogen-containing gas and the oxygen-containing gas are supplied through branch pipes, respectively, to be met at the metal component.

6. The method of claim 5, wherein the nitrogen-containing gas and the oxygen-containing gas react with moisture contained therein or moisture adhering to the surface of at least one of the branch pipes and the metal component to generate the nitric acid.

7. The method of claim 1, wherein the nitric acid is directly supplied to the metal component.

8. The method of claim 1, wherein the removing of the chromium from the passivation film comprises depressurizing an atmosphere around the metal component.

9. The method of claim 1, wherein the removing of the chromium from the passivation film comprises heating an atmosphere around the metal component.

10. The method of claim 1, wherein the removing of the chromium from the passivation film is performed until a concentration of the chromium in a surface layer region which is from a surface of the passivation film to a predetermined depth or less becomes equal to or less than a predetermined value.

11. The method of claim 10, wherein the predetermined depth is 2 nm.

12. The method of claim 1, wherein the metal component is a pipe, and the surface is an inner circumferential surface of the pipe.

13. The method of claim 12, wherein the pipe is formed of a stainless steel.

14. The method of claim 12, wherein the pipe is configured to supply an oxidizing gas.

15. A substrate processing method, wherein a pipe is connected to a process chamber of a substrate processing apparatus, and the method comprises processing a substrate by supplying a process gas from the pipe to the process chamber after performing the metal contamination preventing method of claim 12.

16. A metal contamination preventing apparatus for performing a metal contamination preventing process prior to using a metal component coated with a passivation film formed of chromium oxide, the apparatus comprising:
a nitric-acid supply unit configured to supply a nitric acid to the passivation film covering a surface of the metal component; and
an evaporation unit configured to evaporate chromium nitrate generated by a reaction of the nitric acid, which has been supplied by the nitric-acid supply unit, and the chromium oxide.

17. The apparatus of claim 16, wherein the nitric-acid supply unit has first and second branch pipes configured to individually supply a nitrogen-containing gas and an oxygen-containing gas to the metal component.

18. The apparatus of claim 17, wherein an ozonizer is connected to the second branch pipe configured to supply the oxygen-containing gas, and
wherein the oxygen-containing gas comprises ozone generated by the ozonizer.

19. The apparatus of claim 18, wherein the ozonizer is configured to receive oxygen and nitrogen, and the ozonizer is capable of generating a nitric acid and/or nitrogen in addition to the ozone.

20. The apparatus of claim 16, wherein the evaporation unit comprises a depressurization part configured to depressurize an atmosphere around the metal component.

21. The apparatus of claim 16, wherein the evaporation unit comprises a heating part configured to heat an atmosphere around the metal component.

22. The apparatus of claim 16, wherein the metal component is a pipe, and the surface is an inner circumferential surface of the pipe.

23. The apparatus of claim 22, wherein the pipe is formed of a stainless steel.

24. The apparatus of claim 22, wherein the pipe is configured to supply an oxidizing gas.

25. A substrate processing apparatus comprising:
the metal contamination preventing apparatus of claim 22;
the pipe to which the metal contamination preventing apparatus is connected; and
a process chamber connected to the pipe,
wherein the process chamber is capable of processing a substrate received therein by supplying a process gas through the pipe.
